(19) United States
(12) Patent Application Publication
(10) Pub. No.: US 2023/0373021 A1
(43) Pub. Date: Nov. 23, 2023

(54) CUTTING TOOL

(71) Applicant: MATE GmbH, Kirccham bei Vorchdorf (AT)

(72) Inventors: Michael Steinkogler, Ebensee (AT); Wilhelm Klaus Kubin, Gmunden (AT)

(73) Assignee: MATE GmbH, Kirccham bei Vorchdorf (AT)

(21) Appl. No.: 18/027,231

(22) PCT Filed: Sep. 6, 2021
(86) PCT No.: PCT/AT2021/060313

§ 371 Date: Mar. 20, 2023

(30) Foreign Application Priority Data
Sep. 18, 2020 (AT) A50796/2020
Oct. 8, 2020 (AT) A50864/2020

(51) Int. Cl. B23D 61/06; B23C 5/08

(52) U.S. Cl. CPC B23D 61/06; B23C 5/08

(57) ABSTRACT

A cutting tool, such as a saw blade, has a carrier forming at least one cylindrical receptacle and at least one abutment jaw for a cutting insert. The cutting insert includes a cylindrical main cutting body and a cutting edge protruding radially therefrom, which on the back of the cutting edge has at least one abutment for the abutment jaw. The cutting insert can be inserted into the receptacle transversely to the cutting direction and, in the inserted position, can be rotated between an inserted position and a cutting position. The cutting insert is secured in the cutting position using an anti-rotation lock and is inserted into the cylindrical receptacle in the manner of a bayonet connection. Despite simple production and mounting conditions, the cutting tool ensures adequate stability and strength of interchangeable cutting inserts on the carrier such that thin-cut applications, such as carrier thicknesses of under 6 mm.

### TECHNICAL FIELD The system described herein relates to a cutting tool, in particular a saw blade.

### BACKGROUND

Circular saw blades with replaceable cutting inserts are known from US20020112590A1. For this purpose, the circular saw blade forms a carrier which has several cylindrical receptacles and limit stop jaws so that the respective cutting inserts can be inserted into the receptacles transversely to the cutting direction, in particular axis-parallel with respect to the carrier. During insertion into the cylindrical receptacle, the cutting insert is rotated with respect to a pivot axis parallel to the carrier axis from an inserted position to a cutting position. In the cutting position, a centering spring arranged essentially radially on the limit stop jaw engages in a corresponding centering groove of the inserted cutting insert. To prevent rotation, a locking screw is provided which fixes the cutting insert in the receptacle. The disadvantage of this, however, is that due to the design restrictions regarding a minimum screw diameter, saw blade thicknesses of less than 6 mm cannot be realized without further measures. In addition, there is the difficulty that with lower saw blade thicknesses there is insufficient stability and strength of the cutting insert on the carrier during operation. For these reasons, such cutting insert systems could not be used satisfactorily for thin-cutting applications.

### SUMMARY OF THE INVENTION

There is thus a need for a cutting tool of the type described at the outset which, despite simple manufacturing and assembly conditions, ensures sufficient stability and strength of the replaceable cutting inserts on the beam so that thin-cutting applications, especially with beam thicknesses of less than 6 mm, are reliably possible.

The system described herein solves the given problem in that the cutting insert is inserted into the cylindrical receptacle in the manner of a bayonet lock.

Inserting a cutting insert into a cylindrical receptacle in the manner of a bayonet lock means that the cutting insert and the cylindrical receptacle are pushed into each other in a direction of the cylinder axis into an inserted position and are rotated in an opposite direction with respect to the cylinder axis into a cutting position in order to establish the connection between the cutting insert and the cylindrical receptacle. In some embodiments, the cylinder axis of both the receptacle and the main cutting body essentially coincide. This not only enables simple assembly or disassembly of the cutting inserts, which can be carried out manually in particular when the cutting tool is already installed, but the respective cutting insert is already fixed in the cylindrical receptacle with sufficient stability in the cutting position, so that a mechanism for corresponding anti-rotation, for example bolts or spring steel elements, can be dimensioned smaller and in particular screws can be omitted as anti-rotation means. It is understood that automated assembly and disassembly of the cutting inserts using appropriate insertion machines is also possible in principle. In addition, due to the measures according to the system described herein, both a uniform cutting force transfer via the cylindrical receptacle and the at least one limit stop jaw into the carrier can take place during operation, and the risk of the cutting insert being detached from the receptacle due to force effects extending transversely to the cutting direction, e.g. due to impacts or blows, can be reduced. Overall, the features according to the system described herein allow cutting insert fractures to be reduced, so that the prerequisite is created for providing cutting tools for thin-cutting applications, in particular saw blades. Thus, despite a carrier thickness of less than 6 mm, the tool can still be easily fitted with replaceable cutting inserts, preferably automatically. The fact that the cutting insert is inserted into the cylindrical receptacle in the manner of a bayonet lock ensures that the cutting insert is positively fixed in the cylindrical receptacle transversely to the cutting direction. Corresponding locking mechanisms of the bayonet lock can be provided over the circumferential area of the cylindrical receptacle, which ensure the necessary hold of the cutting insert in the receptacle over an appropriate area. The cutting edge has at least one limit stop for the limit stop jaw on the back of the cutting edge. On the back of the cutting edge means in particular that the limit stop is provided on a back of the cutting edge opposite the rake face on which a cut chip runs off. By way of clarification, it should be noted that in the present case the blade of the cutting insert is referred to as the cutting edge for the sake of simplicity.

Particularly favorable design conditions are obtained if at least one lug insertable into an undercut groove of the receptacle is provided on the cylinder circumference of the cutting insert. The undercut groove has a first insertion guide groove extending parallel to the cylinder axis of the cylindrical receptacle, similar to a bayonet lock, and a second rotary guide groove adjoining the undercut groove essentially transversely in the circumferential direction of the receptacle. When the cutting insert is inserted into the receptacle, the lug of the cutting insert can thus first be displaced along the insertion guide groove so that the cutting insert assumes an inserted position in the receptacle. If the cutting insert and the receptacle are rotated in opposite directions with respect to the cylinder axis, the lug can slide along the rotary guide groove so that the cutting insert finally assumes a cutting position with respect to the receptacle. The lug can be designed, for example, as a kind of comb whose surfaces are inclined to each other and to the cylinder circumference of the cutting insert. Accordingly, the insertion guide groove cross-section may correspond substantially to the longitudinal section of the lug, whereas the rotary guide groove cross-section may correspond substantially to the cross-section of the lug, with the lug being displaceable with clearance along the grooves.

Conversely, it is also conceivable that, analogously to the above features, at least one lug insertable into an undercut groove of the cutting insert is provided on the inner cylinder circumference of the receptacle. By way of clarification, it should be noted that the inner cylinder circumference of the receptacle means the surface of the receptacle facing the cylinder circumference of the cutting insert.

In order to facilitate both simpler assembly conditions and uniform wear of the cutting inserts in operation, it is proposed that the cutting edge of the cutting insert protrudes radially from the cylindrical main cutting body of the cutting insert inserted in the cylindrical receptacle, wherein the cutting edge has two limit stop surfaces on the back of the cutting edge, preferably arranged at an obtuse angle to one another, for centering the cutting insert on the limit stop jaw. The two surfaces arranged at an angle to one another are preferably also inclined relative to the two cylinder base surfaces of the main cutting body. As a result of these features, reliable centering of the cutting insert in the receptacle can be achieved despite simple manufacturing and assembly conditions, so that uniform loading of all cutting inserts of the tool according to the system described herein can be achieved.

In order to further reduce cutting insert fractures, it is recommended that the cutting insert has two limit stops distributed over a cylinder circumference of the cutting insert for centering the cutting insert on two limit stop jaws, wherein the limit stops are opposite one another with respect to the cylinder axis of the cylindrical main cutting body. This enables a compact fit of the cutting insert in the receptacle, so that a particularly advantageous introduction of cutting force or a particularly uniform transfer of cutting force into the carrier can take place. It is understood that at least one of the limit stops or the corresponding limit stop jaws can have limit stop surfaces arranged at an angle to one another, as described above.

In some embodiments, the carrier has a clearance for anti-rotation, which clearance adjoins the inner cylinder circumference of the receptacle and is opposite the limit stop jaw. This not only results in simple manufacturing conditions for a tool with sufficient strength for thin-cutting applications, but also allows a corresponding anti-rotation mechanism to be inserted or replaced without difficulty due to the easy accessibility of the clearance. Preferably, the direction of insertion of the anti-rotation mechanism into the clearance is also parallel to the cylinder axis or the axis of rotation of the carrier.

In this context, it is particularly advantageous if the anti-rotation mechanism is formed by a tension spring which is supported on two flanks of the clearance on the one hand and is set against the cylindrical main cutting body on the other. For reliable clamping conditions, the corresponding supporting and adjusting directions may be at right angles to each other.

Additional stability and at the same time simple assembly conditions result if a safety catch is arranged on the cylinder circumference of the cutting insert for the anti-rotation mechanism in the cutting position. This allows the tensioning of the tensioning spring for the anti-rotation mechanism to be carried out in a simple manner solely by the relative rotary movement of the cutting insert and the receptacle in the cutting position.

In order to further secure the tension spring in such a way that the tension spring cannot be released from the clearance during operation, in particular due to external impact or shock effects, it is proposed that a tension spring is inserted into guide receptacles on the flanks of the clearance. Particularly preferably, the guide receptacles form limit stops for the relevant tension spring sections inserted in the guide receptacles in or against the insertion direction of the tension spring.

The system described herein also relates to a cutting insert for a cutting tool, having a cylindrical main cutting body and a cutting edge protruding radially therefrom, which on the back of the cutting edge has at least one limit stop for the limit stop jaw. At least one lug and/or at least one groove is arranged on the cylinder circumference of the cutting insert, wherein the at least one lug and/or at least one groove is designed in such a way that the cutting insert can be inserted in the manner of a bayonet lock into a receptacle of a tool, in particular a circular saw blade. Further embodiments are described herein.

In order to create particularly favorable assembly conditions despite simple manufacturing conditions, on the one hand, and to enable a stable fit of the cutting insert in a tool receptacle, on the other hand, it is proposed that the safety catch forms a half-kidney-shaped catch guide groove extending over a circumferential section of the main cutting body with a lower-lying receiving bend and a higher-lying tensioning bend. The lower-lying receiving bend of the catch guide groove allows easy insertion of the cutting insert into a tool receptacle, wherein any anti-rotation mechanism section, e.g. the setting section of a tension spring, engages in the receiving bend with play respectively without contact. When the cutting insert or the carrier is rotated into the cutting position, the anti-rotation mechanism section slides, resting against the half-kidney-shaped catch guide groove, into the higher tensioning bend, where the anti-rotation mechanism is held in a force-fit manner and is thus secured.

### BRIEF DESCRIPTION OF DRAWINGS

In the drawing, the subject matter of the system described herein is shown by way of example, wherein:

FIG. 1 shows a schematic partial view of a tool according to the system described herein in a plan view,

FIG. 2 shows a detailed view of FIG. 1 on a larger scale, showing a cutting position on the left and an inserted position on the right,

FIG. 3 shows an exploded view of a cutting insert, a cylindrical receptacle and a tension spring in a first oblique view on an even larger scale, and

FIG. 4 shows an exploded view corresponding to FIG. 3 in a further oblique view.

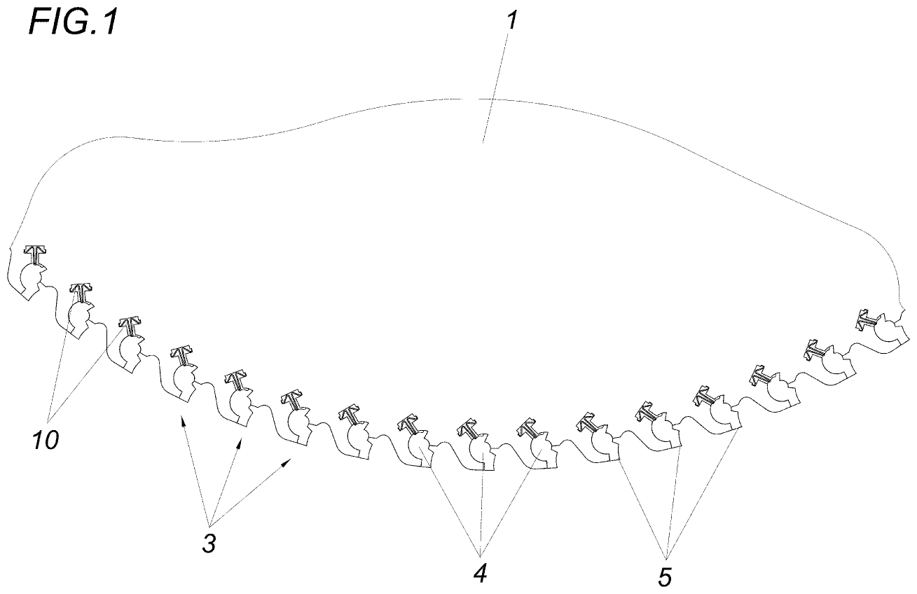

### DETAILED DESCRIPTION OF VARIOUS EMBODIMENTS

A cutting tool according to the system described herein is designed as a circular saw blade, the carrier 1 of which has several circumferentially arranged cylindrical receptacles 2, into each of which cutting inserts 3 according to the system described herein are inserted. The cutting inserts 3 each have a cylindrical main cutting body 4 and a cutting edge 5 projecting radially therefrom. In addition, the cutting insert 3 has two limit stops 6, 7 distributed over a cylinder circumference of the cutting insert 3 for centering the cutting insert 3 on two limit stop jaws 8, 9, with the limit stops 6, 7 being opposite one another with respect to the cylinder axis of the cylindrical main cutting body 4.

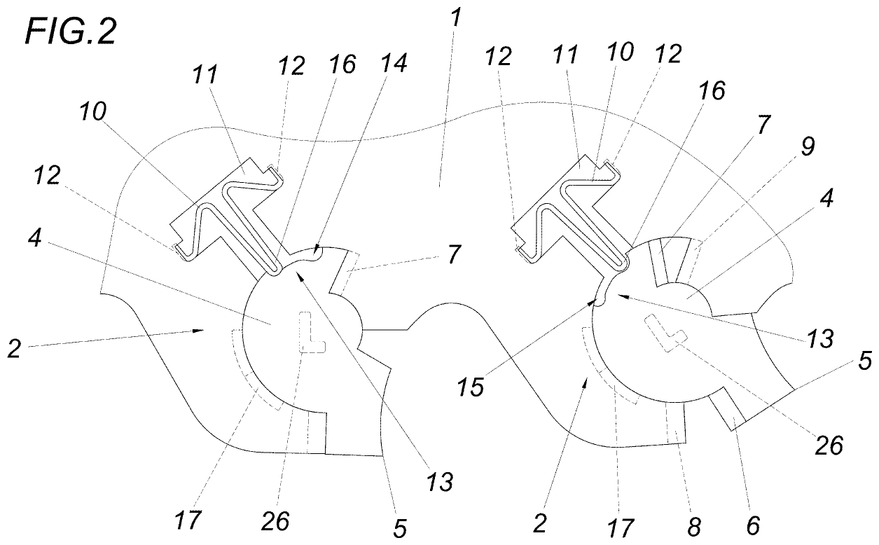

The cutting insert 3 can be inserted into the receptacle 2 transversely to the cutting direction and rotated in the inserted position between an inserted position and a cutting position, as indicated by way of example in FIG. 2. The cutting insert 3 is secured in the cutting position shown on the left in FIG. 2 by an anti-rotation mechanism, which in the present exemplary embodiment is designed as a tension spring 10. The tension spring 10 is inserted into a clearance 11 of the carrier 1, is supported on two flanks 12 of the clearance 11 and is set against the cylindrical main cutting body 4.

In addition, a safety catch for the tension spring 10 in the cutting position is arranged on the cylinder circumference of the cutting insert 3. The safety catch forms a half-kidney-shaped catch guide groove 13 extending over a circumferential section of the main cutting body 4 with a lower receiving bend 14 and a higher tensioning bend 15. In the inserted position shown on the right in FIG. 2, the tension spring 10 engages with an adjusting section 16 thereof with play in the lower receiving bend. If the cutting insert 3 or the carrier 1 is rotated into the cutting position shown on the left in FIG. 2, the adjusting section 16 slides into the higher tensioning bend 15, resting against the half-kidney-shaped catch guide groove 13, where the adjusting section 16 is held in a force-fit manner and thus secured.

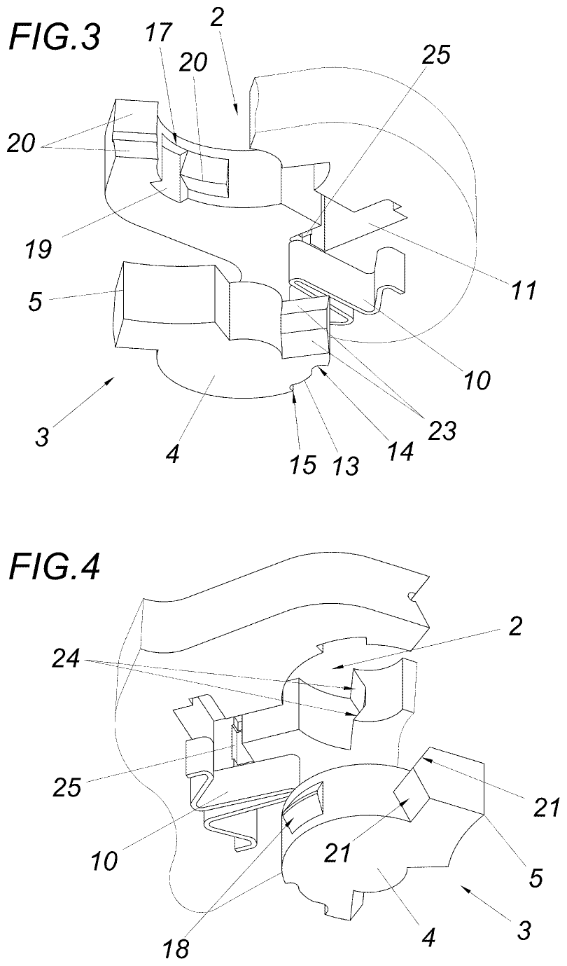

Looking at FIG. 3 and FIG. 4, it can be seen that according to the present exemplary embodiment, a lug 18 is provided on the cylinder circumference of the cutting insert 3, which can be inserted into an undercut groove 17 of the receptacle 2. The undercut groove 17 has a first insertion guide groove 19 extending parallel to the cylinder axis of the receptacle 2 in the manner of a bayonet lock (i.e., using a bayonet lock mechanism), which is adjoined transversely thereto in the circumferential direction of the cylinder of the receptacle 2 by a second rotary guide groove 20. When inserting the cutting insert 3 into the receptacle 2, the lug 18 can thus first be displaced along the insertion guide groove 19 so that the cutting insert 3 assumes an inserted position in the receptacle 2. If the cutting insert 3 and the receptacle 2 are rotated in opposite directions with respect to the cylinder axis, the lug 18 can slide along the rotary guide groove 20 so that the cutting insert 3 assumes a cutting position with respect to the receptacle 2. As is shown in FIG. 4, the lug 18 is designed, for example, as a kind of comb whose surfaces are inclined with respect to each other and with respect to the cylinder circumference of the cutting insert 3. Accordingly, the insertion guide groove cross-section 19 corresponds substantially to the longitudinal cross-section of the exemplary comb-shaped lug 18, whereas the rotary guide groove cross-section 20 corresponds substantially to the cross-section of the lug 18, with the lug 18 being displaceable with clearance along the grooves 19, 20.

As can also be seen from FIGS. 3 and 4, the limit stop 6 on the back of the cutting edge has two limit stop surfaces 21 arranged at an angle to one another for centering the cutting insert 3 on the limit stop jaw 8, which also has two inclined limit stop surfaces 22 for this purpose. The limit stop 7 opposite the limit stop 6 with respect to the cylinder axis of the main cutting body 4, as well as the corresponding limit stop jaw 9, also have limit stop surfaces 23 and 24, respectively, which are inclined with respect to each other.

In addition, it can be seen in FIGS. 3 and 4 that the tension spring 10 is inserted into guide receptacles 25 on the flanks 12 of the clearance 11.

The cutting inserts 3 can be inserted and removed manually in a simple manner from a cutting tool in the installed state in the cylindrical receptacles 2 with the aid of a corresponding insertion tool. FIG. 2 schematically shows an exemplary driver profile 26 for an insertion tool.

1. A cutting tool having a carrier, comprising:
at least one cylindrical receptacle; and
at least one limit stop jaw for a cutting insert that includes a cylindrical main cutting body and a cutting edge protruding radially therefrom, wherein a back of the cutting edge has at least one limit stop for the limit stop jaw, the cutting insert being insertable into the receptacle transversely to a cutting direction, and, in an inserted position, being rotatable between the inserted position and a cutting position, the cutting insert being secured in the cutting position by an anti-rotation mechanism, wherein inserting the cutting insert into the cylindrical receptacle uses a bayonet lock.

2. The cutting tool according to claim 1, wherein at least one lug is insertable into an undercut groove of the receptacle and is provided on a cylinder circumference of the cutting insert.

3. The cutting tool according to claim 1, wherein at least one lug is insertable into an undercut groove of the cutting insert and is provided on an inner cylinder circumference of the receptacle.

4. The cutting tool according to claim 1, wherein the cutting edge has, on the back of the cutting edge, two limit stop surfaces arranged at an angle to one another for centering the cutting insert on the limit stop jaw.

5. The cutting tool according to claim 4, wherein the cutting insert has, distributed over a cylinder circumference thereof, two limit stops for centering the cutting insert on the limit stop jaw and an other limit stop jaw, wherein the limit stops are located opposite one another with respect to a cylinder axis of the cylindrical main cutting body.

6. The cutting tool according to claim 1, wherein the carrier has a clearance for the anti-rotation, and wherein the clearance adjoins an inner cylinder circumference of the receptacle and is opposite to the limit stop jaw.

7. The cutting tool according to claim 6, wherein anti-rotation is provided by a tension spring which is supported on two flanks of the clearance and is set against the cylindrical main cutting body.

8. The cutting tool according to claim 6, wherein a safety catch for anti-rotation in the cutting position is arranged on a cylinder circumference of the cutting insert.

9. The cutting tool according to claim 7, wherein a tension spring is inserted into guide receptacles on the flanks of the clearance.

10. A cutting insert for a cutting tool, the cutting tool having a cylindrical main cutting body and a cutting edge protruding radially therefrom and having on a back thereof at least one limit stop for an limit stop jaw, the cutting insert comprising:
at least one lug and/or at least one groove arranged on a cylinder circumference of the cutting insert; and
a bayonet lock mechanism that uses the at least one lug and/or at least one groove so that the cutting insert is insertable into a receptacle of a tool in a manner of a bayonet lock.

11. The cutting insert according to claim 10, wherein the cutting edge has on the back of the cutting edge two limit stop surfaces arranged at an angle to one another for centering the cutting insert in a the receptacle of the tool and wherein the receptacle is cylindrical.

12. The cutting insert according to claim 10, wherein the cutting insert has two limit stops distributed over a cylinder circumference of the main cutting body for centering the cutting insert in a the receptacle of the tool, wherein the limit stops lie opposite one another with respect to a cylinder axis of the main cutting body and wherein the receptacle is cylindrical.

13. The cutting insert according to claim 10, wherein a safety catch for anti-rotation in a cutting position is arranged on a cylinder circumference of the main cutting body.

14. The cutting insert according to claim 13, wherein the safety catch forms a half-kidney-shaped catch guide groove extending over a circumferential section of the main cutting body with a lower-lying receiving bend and a higher-lying tensioning bend.

15. The cutting tool according to claim 1, wherein the cutting tool is a saw blade.

16. The cutting tool according to claim 2, wherein the carrier has a clearance for anti-rotation and wherein the clearance adjoins an inner cylinder circumference of the receptacle and is opposite to the limit stop jaw.

17. The cutting tool according to claim 16, wherein anti-rotation is provided by a tension spring-which is supported on two flanks of the clearance and is set against the cylindrical main cutting body.

18. The cutting tool according to claim 5, wherein the carrier has a clearance for anti-rotation and wherein the clearance adjoins an inner cylinder circumference of the receptacle and is opposite to the limit stop jaw.

19. The cutting tool according to claim 18, wherein anti-rotation is provided by a tension spring-which is supported on two flanks of the clearance and is set against the cylindrical main cutting body.

20. The cutting insert according to claim 12, wherein a safety catch for anti-rotation in a cutting position is arranged on a cylinder circumference of the main cutting body.
